(19) United States
(12) Patent Application Publication
(10) Pub. No.: US 2023/0069027 A1
(43) Pub. Date: Mar. 2, 2023

(54) INFORMATION PROCESSING DEVICE, MOBILE DEVICE, INFORMATION PROCESSING METHOD, AND STORAGE MEDIUM

(71) Applicant: CANON KABUSHIKI KAISHA, Tokyo (JP)

(72) Inventor: Ryosuke Mizuno, Chiba (JP)

(21) Appl. No.: 17/820,397

(22) Filed: Aug. 17, 2022

(30) Foreign Application Priority Data
Aug. 27, 2021 (JP) 2021-139224

(51) Int. Cl. G01C 21/00; G06T 7/00; G06T 7/73; G06T 7/246

(52) U.S. Cl. CPC G01C 21/3807; G06T 7/0002; G06T 7/73; G06T 7/246; G06T 2207/30244; G06T 2207/30252

(57) ABSTRACT

An information processing device or the like capable of notifying of appropriateness of map information is provided.

In the information processing device, sensor information is acquired from one or more sensors, map information around the sensor is generated based on the sensor information, appropriateness of the map information is estimated based on at least one piece of information between the sensor information and the map information generated by the map information generation unit, and the appropriateness is notified of.

### BACKGROUND OF THE INVENTION

### Field of the Invention

The present invention relates to an information processing device, a mobile device, an information processing method, and a storage medium for generating map information.

### Description of the Related Art

Autonomous traveling vehicles such as automated guided vehicles are used in factories or distribution warehouses. As methods of estimating positions and postures of such autonomous traveling vehicles, cameras or laser imaging detection and ranging (LIDAR) sensors are used as sensors. Methods of acquiring position and posture differences at each of times from results obtained by measuring environments around vehicles and comparing the position and posture differences with map information generated in advance to calculate position and posture values are known.

Most map information used to estimate positions and postures of such types of autonomous traveling vehicles is generated manually using sensors such as cameras in advance by users. As one of the methods of generating highly accurate map information, a method of using map information to be generated as a closed route was suggested (M. A Raul, J. M. M. Montiel and J. D. Tardos, “ORB-SLAM: A Versatile and Accurate Monocular SLAM System” Trans. Robotics vol. 31, 2015).

As a method of calculating feature points of an object to generate map information from imaged data, a smallest univalue segment assimilating nucleus (SUSAN) operator (S. M. Smith and J. M. Brady, “SUSAN-a new approach to low level image processing,” Int'l J Comput. Vision, vol. 23, no. 1, pp. 45 to 78, 1997) is known.

A method of guiding a mobile object so that a more reliable closed route is formed was suggested (Japanese Unexamined Patent Publication No. 2017-146952).

However, in the method of Japanese Unexamined Patent Publication No. 2017-146952, there is no way in which a user can ascertain whether map information is appropriate in terms of accuracy. The present invention has been devised in view of the foregoing problem and one of objectives of the present invention is to provide an information processing device or the like capable of notifying of appropriateness of map information.

### SUMMARY OF THE INVENTION

To solve the foregoing problem, according to an aspect of the present invention, an information processing device includes at least one processor or circuit configured to function as: a sensor information acquisition unit configured to acquire sensor information from one or more sensors; a map information generation unit configured to generate map information around the sensor based on the sensor information; a map appropriateness estimation unit configured to estimate appropriateness of the map information based on at least one piece of information between the sensor information and the map information generated by the map information generation unit; and a notification unit configured to notify of the appropriateness.

Further features of the present invention will become apparent from the following description of embodiments with reference to the attached drawings.

### BRIEF DESCRIPTION OF THE DRAWINGS

FIG. 1 is a functional block diagram illustrating a map information generation system in which an information processing device according to a first embodiment of the present invention is used.

FIG. 2 is a flowchart illustrating a processing flow in which appropriateness of map information of the map information generation system according to the first embodiment is estimated.

FIG. 3 is a diagram illustrating an example of a method of notifying appropriateness of the map information according to the first embodiment.

FIG. 4 is a flowchart illustrating a processing flow in which appropriateness of map information according to a fifth embodiment is estimated.

### DESCRIPTION OF THE EMBODIMENTS

Hereinafter, with reference to the accompanying drawings, favorable modes of the present invention will be described using embodiments. In each diagram, the same reference signs are applied to the same members or elements, and duplicate description will be omitted or simplified.

### First Embodiment

In a first embodiment, an example in which a user moves a mobile object with, for example, a remote controller and a method according to the present invention is applied to a map information generation system generating map information based on an image captured with a camera mounted on the mobile object will be described.

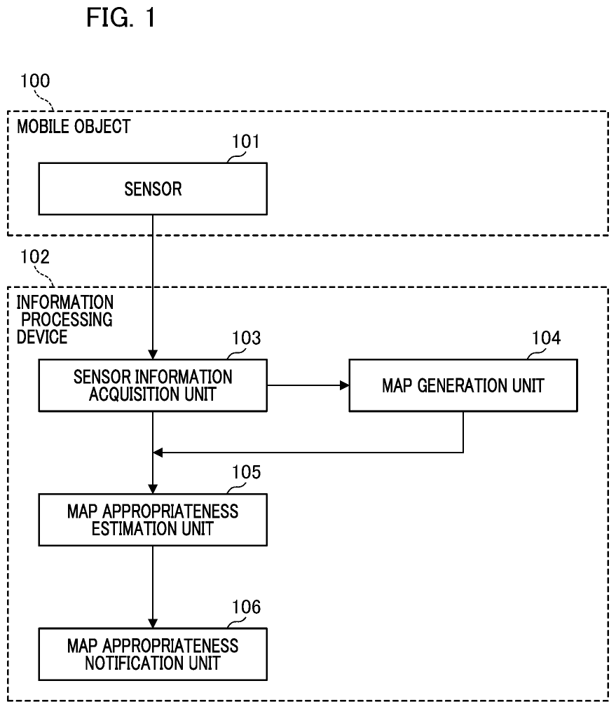

FIG. 1 is a functional block diagram illustrating a map information generation system in which an information processing device according to the first embodiment of the present invention is used. The map information generation system according to the present embodiment includes a mobile object 100 serving as a mobile device and an information processing device 102. The mobile object 100 has, for example, a shape of an AMR (autonomous traveling robot device). The information processing device 102 may be mounted on the AMR (the autonomous traveling robot device) which is a mobile object.

Some of functional blocks illustrated in FIG. 1 are realized by causing a computer (not illustrated) included in the information processing device or the like to execute a computer program stored in a memory serving as a storage medium (not illustrated). Some or all of the functional blocks may be realized by hardware. As the hardware, a dedicated circuit (ASIC), a processor (a reconfigurable processor or a DSP) or the like can be used.

Each functional block of the information processing device 102 illustrated in FIG. 1 may not be embedded in the same casing and the information processing device may be configured by other devices connected to each other via a signal line. A CPU serving as a computer is embedded in the information processing device 102. The CPU controls an operation of each unit of the entire device based on a computer program stored in a memory serving as a storage medium.

In the present embodiment, the mobile object 100 on which a camera is mounted as a sensor collects map information, generates a 3-dimensional map, and estimates appropriateness of the 3-dimensional map information. Here, the map information includes a 3-dimensional array of feature points detected from an image captured with the camera and the appropriateness of the 3-dimensional map information is estimated based on detection reliability of the feature points.

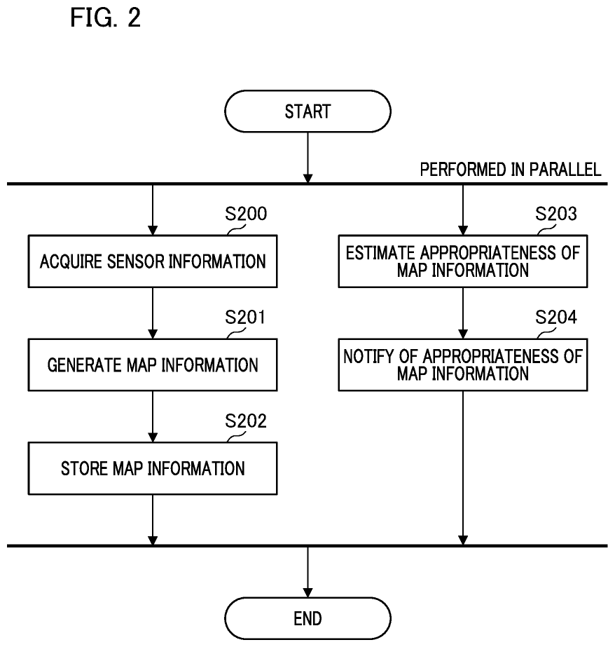

The present embodiment will be described with reference to FIGS. 1 and 2. In FIG. 1, reference numeral 100 denotes a mobile object in the map information generation system and reference numeral 101 denotes, for example, an image sensor (a camera sensor) such as a CMOS image sensor that is mounted on the mobile object 100 and acquires 2-dimensionally arrayed data of luminance as imaged data.

Reference numeral 102 denotes an information processing device in the map information generation system and reference numeral 103 denotes a sensor information acquisition unit that is a part of the information processing device 102 and acquires sensor information from one or more sensors 101. In the present embodiment, imaged data is acquired as sensor information. Reference numeral 104 denotes a map generation unit that generates map information of a surrounding environment of the sensor 101 based on the sensor information acquired by the sensor information acquisition unit 103.

Reference numeral 105 denotes a map appropriateness estimation unit that estimates appropriateness of the map information based on the sensor information acquired by the sensor information acquisition unit 103 or the map information generated by the map generation unit 104. Reference numeral 106 denotes a map appropriateness notification unit that notifies of the appropriateness estimated by the map appropriateness estimation unit 105. The information processing device 102 can be mounted on the mobile object 100. When the information processing device 102 is not mounted on the mobile object 100, the information processing device 102 controls the mobile object 100 via a communication network.

Next, FIG. 2 is a flowchart illustrating a processing flow in which appropriateness of the map information of the map information generation system according to the first embodiment is estimated. FIG. 2 illustrates an example in which a process is performed in parallel, but the process may be performed in series. An operation of each step in FIG. 2 is performed by causing a computer in the information processing device 102 to execute a computer program stored in the memory.

Step S200 is a step in which the sensor information acquisition unit 103 in FIG. 1 acquires the sensor information from the sensor 101 and stores the sensor information in a retention unit (not illustrated). Step S201 is a step in which the map generation unit 104 in FIG. 1 generates map information based on the sensor information acquired in step S200.

The map information in the present embodiment includes a 3-dimensional position information group of feature points of an object calculated from imaged data. The feature points are calculated using, for example, a smallest univalue segment assimilating nucleus (SUSAN) operator (S. M. Smith and J. M. Brady, “SUSAN-a new approach to low level image processing,” Int'l J Comput. Vision, vol. 23, no. 1, pp. 45 to 78, 1997).

A method of calculating feature points is not limited to this method and any method can be used as long as the method is a method in which feature points in imaged data can be calculated. For example, feature points may be calculated from a plurality of pieces of imaged data and feature points based on 3-dimensional feature amounts such as signature of histograms of orientations (SHOT) feature amounts.

Step S202 is a step of storing the map information generated in step S201. Step S203 is a step in which the map appropriateness estimation unit 105 in FIG. 1 estimates appropriateness of the map information based on the sensor information acquired by the sensor information acquisition unit 103 or the map information generated by the map generation unit 104. Step S204 is a step in which the map appropriateness notification unit 106 in FIG. 1 notifies a user of the appropriateness of the map information estimated in step S203.

In the estimation of the appropriateness of the map information in step S203, reliability of feature points which are the map information generated in step S201 of FIG. 2 is integrated and calculated. Reliability R of each feature point is calculated by obtaining a total sum of absolute values of amounts of change (differences) between luminance of target feature point positions and surrounding luminance of the feature points using the imaged data stored in step S200 and setting a ratio of the total sum to a predetermined threshold (R=total sum of absolute values of amounts of change÷threshold).

Appropriateness X of the map information calculated by integrating the reliability R of each feature point is set as an average value of the reliability R of all the feature points. Accordingly, this means that the map information with higher appropriateness is generated when a value of the appropriateness X is larger. Since the above-mentioned appropriateness X may be any value as long as it indicates that more appropriate map information is generated as the value of the above-described appropriateness X becomes larger. The appropriateness X may be a total sum of the reliability R of all the feature points. Further, the feature points used to calculate the appropriateness X may be designated by the user or limited to a region of interest (ROI) of a system.

The above-described reliability R of each feature point may be calculated from the luminance of positions of the feature points and the surrounding luminance of the feature points although the imaged data acquired and stored in step S200 of FIG. 2 is used. Accordingly, the imaged data may not necessarily be stored in step S200 and the reliability R may be calculated after the imaged data is acquired.

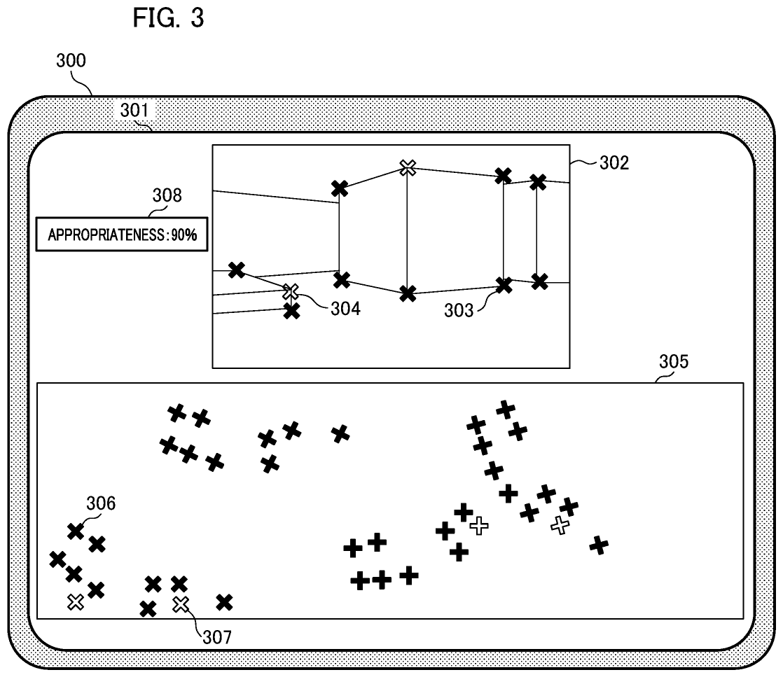

Next, FIG. 3 is a diagram illustrating an example of a method of notifying appropriateness of the map information according to the first embodiment and illustrates an example in which the appropriateness of the map information is notified of using a graphical user interface (GUI) in step S204. Reference numeral 300 denotes a manipulation terminal manipulated by a user and reference numeral 301 denotes a display unit of a manipulation terminal 300. Reference numeral 302 denotes a part of the display unit 301 and an imaged data display unit that displays imaged data at a present time point.

Reference numeral 303 denotes a mark indicating a position of a feature point which is superimposed on the imaged data display unit 302 and at which the reliability R estimated in step S203 is equal to or greater than, for example, 1.0. Reference numeral 304 denotes a mark indicating a position of a feature point which is superimposed on the imaged data display unit 302 and at which the reliability R estimated in step S203 is less than, for example, 1.0.

In the present embodiment, a user is notified of colors of the marks 303 and 304 indicating the positions of the feature points as different colors in accordance with the reliability. However, the marks 303 and 304 may be displayed in any form in which the reliability of the feature points at these marks can be determined to be different. For example, sizes or shapes of the marks may be different from each other. That is, the detection reliability may be notified of using any one of a shape, size, or color of the feature points, or a numeral value.

Accordingly, it can be understood that the appropriateness of the map information is higher when the number of marks 303 superimposed on the imaged data display unit 302 is larger. Reference numeral 305 denotes a part of the display unit 301 and a map overhead view portion in which the map information generated in step S201 of FIG. 2 is displayed (for example, an overhead view portion of an entire feature point group displayed from any height).

Reference numeral 306 denotes a mark which is superimposed and displayed on the map overhead view portion 305 and indicates an overhead view position corresponding to the mark 303 and reference numeral 307 denotes a mark which is superimposed and displayed on the map overhead view portion 305 and indicates an overhead view position corresponding to the mark 304. In this way, the marks superimposed and displayed on the map overhead view portion 305 represent that the appropriateness of the map information is higher when the number of marks 306 is larger. Reference numeral 308 denotes an appropriateness display portion in which the appropriateness of the map information calculated in step S203 of FIG. 2 is displayed as percentages.

Instead of displaying the appropriateness of the map information as a numeral value, for example, a stimulus in which magnitude of the appropriateness can be perceived with a sense such as a visual and auditory sense or a tactile sense may be generated. Specifically, in accordance with the magnitude of the appropriateness, the map information may be displayed separately with a size or color of a predetermined character, magnitude of vibration, a sound, or the like. As described above, according to the present embodiment, the appropriateness of the map information can be estimated using detection reliability of feature points of an object and a user can be notified of the appropriateness of the map information which is being generated.

In the foregoing embodiment, the appropriateness of the map information estimated in step S203 of FIG. 2 is estimated based on the detection reliability of the feature points calculated from the amounts of change (differences) between the luminance of the positions of the feature points and the surrounding luminance of the feature points. However, the detection reliability of the feature points may be estimated based on luminance of the imaged data.

That is, the reliability R of each feature point estimated in step S203 of FIG. 2 may be estimated by combining contrasts of single pieces of imaged data. Specifically, the reliability R of each feature point is calculated using minimum luminance IMin and maximum luminance Imax of each piece of imaged data based on, for example, the following Expressions 1 and 2.

Contrast of single imaged data=(IMax−IMin)÷(IMax+IMin) . . . (Expression 1)

R=AVG (contrast of single imaged data) . . . (Expression 2)

When the detection reliability is estimated by such calculation, the feature points have an increasing reliability as the reliability R of the feature points becomes closer to 1.0 (the contrast becomes stronger). The user can ascertain that the map information with the high appropriateness has been generated.

### Second Embodiment

In the first embodiment, the method of calculating the appropriateness of the map information which is being generated based on the detection reliability of the feature points of the object calculated from the sensor information and notifying of the appropriateness has been described. In a second embodiment, a distribution of feature points of an object calculated from sensor information is used to estimate appropriateness of map information.

That is, as in the first embodiment, a mobile object on which a camera is mounted as a sensor collects map information, generates a 3-dimensional map, and estimates appropriateness of 3-dimensional map information. In the second embodiment, however, the appropriateness is calculated based on whether there is deviation in a distribution of feature points calculated from the sensor information.

A functional block diagram and a processing flow in which the appropriateness of the map information is estimated in the second embodiment may be the same as those of FIGS. 1 and 2 described in the first embodiment. Hereinafter, a detailed process of step S203 which is a difference from the first embodiment will be described.

In the second embodiment, the appropriateness X of the map information estimated in step S203 of FIG. 2 is estimated from uniformity De of a feature point distribution which are in the imaged data. The uniformity De of the feature point distribution is calculated based on whether there is deviation of the feature points which are in the imaged data.

It is determined whether there is deviation of the feature points as follows. That is, a screen is divided into a plurality of partitions designated by the user or set in advance by the system.

It is determined whether there is the number of feature points equal to or greater than a predetermined threshold at each partition. Specifically, a total sum Dm of the number of partitions in which there are the number of feature points equal to or greater than the predetermined threshold is calculated with Expression 3 and the appropriateness X is calculated with Expression 4.

Dm=COUNT (partitions in which there is the number of feature points equal to or greater than predetermined threshold) . . . (Expression 3)

X=Dm/(number of all partitions) . . . (Expression 4)

The appropriateness X of the map information calculated with the foregoing Expression 4 is obtained by estimating appropriateness of the map information based on a distribution of the feature points of an object and is a ratio of a feature point distribution to the number of all partitions. Accordingly, it can be understood that the more appropriate map information is generated as the appropriateness X is closer to 1.0.

The above-described partitions are 2-dimensional based on the number of dimensions by which the feature points are calculated, but a region may be divided. Accordingly, the divided partitions may be 3-dimensional.

In this case, with the uniformity De of the feature point distribution, whether there are the number of feature points equal to or greater than the predetermined threshold in each of the divided 3-dimensional partitions is calculated. When it is determined whether there is deviation of the feature points, the partitions may be calculated using the foregoing Expressions 3 and 4 as in the 2-dimensional case.

As described above, in the second embodiment, by estimating the appropriateness of the map information using the distribution of the feature points of the object, it is possible to notify of the appropriateness of the map information which is being generated.

In the second embodiment, the appropriateness of the map information estimated in step S203 is estimated based on whether there is the deviation in the distribution of the feature points of the object. However, the appropriateness of the map information may be estimated based on the number of pieces of imaged data included in the feature points used to generate the map information.

That is, the appropriateness X of the map information estimated in step S203 is calculated as follows. For example, with regard to imaged data during a predetermined period designated by the user or set in advance by the system, the number of pieces of imaged data having the number of feature points equal to or greater than the predetermined threshold is calculated and a ratio of the number of pieces of imaged data is calculated based on Expression 5 for the estimation.

X=number of pieces of imaged data having number of feature points equal to or greater than predetermined threshold±number of all pieces of imaged data . . . (Expression 5)

That is, by calculating the number of pieces of imaged data having the number of feature points equal to or greater than the predetermined threshold during a predetermined period and dividing the number of pieces of imaged data by the number of all pieces of imaged data during the predetermined period, it is possible to calculate the appropriateness X of the map information during the predetermined period.

It is indicated that the more appropriate map information is generated as the appropriateness X of the map information calculated in this way is closer to 1.0.

In the foregoing example, a period in which the above-described appropriateness X of the map information is calculated is set as a section from start to end of the map information generation system, but may be set as a period between two different time points. Accordingly, the foregoing period may be divided into a plurality of periods or a period may be set dynamically based on a subject distance, the length of a time, a time, or the like. Further, it may be suggested that the more appropriate map information is generated as a value of the above-described appropriateness X of the map information is larger. Therefore, the number of pieces of imaged data having the number of feature points equal to or greater than the predetermined threshold per unit time (for example, 1 second) may be displayed at, for example, each unit time.

Further, the example in which the number of pieces of imaged data or the ratio of imaged data having the number of feature points equal to or greater than the predetermined threshold to the number of all pieces of imaged data during the predetermined period is displayed with regard to the appropriateness X of the map information has been described, but the appropriateness may be calculated based on the feature points in the imaged data during the predetermined period. Accordingly, not the number of pieces of imaged data or the ratio of imaged data but a total number, an average value, or the like of the feature points equal to or greater than predetermined reliability in the imaged data during the predetermined period may be displayed. In this case, it can be understood that the map information with higher appropriateness is generated as the value of the appropriateness X is larger.

### Third Embodiment

In the first and second embodiments, the method of calculating appropriateness of the map information which is being generated based on the amount, the distribution, or the like of feature points of the object calculated from sensor information and notifying the appropriateness has been described. In a third embodiment, an example in which appropriateness of map information is estimated using environmental information of a surrounding environment of a sensor which is map information which is being generated will be described.

In the same manner, a mobile object on which a camera is mounted as a sensor collects map information, generates a 3-dimensional map, and estimates appropriateness of 3-dimensional map information. In the third embodiment, the appropriateness is calculated based on whether there is a change in a light source environment in which accuracy of position and posture measurement of a mobile object deteriorates in an environment in which the mobile object is moving. A block diagram and a processing flow in which the appropriateness of the map information is estimated in the third embodiment may be the same as FIGS. 1 and 2 described in the first and second embodiments.

Hereinafter, a detailed process of step S203 which is a difference from the first and second embodiments will be described. In the third embodiment, the appropriateness X of the map information estimated in step S203 of FIG. 2 is estimated based on whether there is an illumination change (a change in illumination) as the environmental information of the surrounding environment of the sensor 101 in FIG. 1. Determination of whether there is the illumination change (the change in illumination) which is the environmental information is determination of whether luminance of imaged data changes over time.

Specifically, the calculation is performed based on luminance dispersion V calculated from an average luminance group Y {Y0, Y1, . . . Yn} of all the pixels of each piece of imaged data in the entire imaged data group {D0, D1, . . . Dn}. When the luminance dispersion V is equal to or greater than a predetermined threshold, it is determined that there is the illuminance change. When the luminance dispersion V is less than the predetermined threshold, it is determined that there is no illuminance change.

In the third embodiment, when the appropriateness X of the map information estimated in step S203 of FIG. 2 is a binary value and it is estimated that there is no illumination change as environmental information, X=1 is set. When it is estimated that there is the illumination change, X=0 is set. Accordingly, a case in which the appropriateness X is 1 indicates that appropriate map information is generated.

Although the above-described appropriateness X is a binary value, it may be determined how much the illumination change is made. Accordingly, the luminance dispersion V estimated in step S203 may be set as the appropriateness X (X=V) of the map information. In this case, since the value of the appropriateness X indicates intensity of luminance dispersion, it is suggested that the map information with higher appropriateness is generated as the value of the appropriateness X is smaller.

In the third embodiment, whether there is the illumination change is determined based on the luminance dispersion of the imaged data acquired from the sensor 101 in FIG. 1, but it may be determined that there is an illumination change. Accordingly, the mobile object 100 in FIG. 1 may be operating or stop. Further, since the luminance dispersion may be calculated from average luminance of each piece of imaged data, the luminance dispersion may be calculated from average luminance of a specific region of the imaged data.

When there is the illumination change, there is a big difference between two time points in the average luminance value of the imaged data acquired from the sensor 101 in FIG. 1. Accordingly, when a difference in the average luminance between two time points is equal to or greater than a predetermined threshold, it is determined that there is the illumination change. When the difference is less than the predetermined threshold, it is determined that there is no illumination change. The predetermined threshold is assumed to be a value set by the user or set in advance by the system.

As described above, in the third embodiment, by estimating the appropriateness of the map information using the surrounding environment, it is possible to notify of the appropriateness of the map information which is being generated.

In the third embodiment, the appropriateness of the map information estimated in step S203 of FIG. 2 is calculated based on whether there is an illumination change as the environmental information of the surrounding environment of the sensor 101 in FIG. 1. However, the appropriateness X of the map information may be estimated based on whether there is information regarding a moving body in the map information generated in step S201 of FIG. 2 as the environmental information of the surrounding environment of the sensor 101 in FIG. 1.

At this time, whether there is a moving body in the imaged data of the sensor 101 in FIG. 1 is determined by performing pattern matching using a sum of squared difference (SSD) between the imaged data and moving body template data. Then, based on a result of the pattern matching, the appropriateness X of the map information estimated in step S203 of FIG. 2 is estimated.

The moving body includes, for example, a device that has a movement mechanism or an object which can autonomously move. Accordingly, the moving body includes a carriage, a belt conveyer, an elevator, and a person. Further, a tree or the like shaking due to an external force such as wind is also included.

At this time, when similarity calculated by the pattern matching in which the SSD is used in all the imaged data is less than a predetermined threshold, it is determined that there is no moving body. When the similarity is equal to or greater than the predetermined threshold, it is determined that there is a moving body. The predetermined threshold is assumed to be a value set by the user or set in advance by the system.

When the appropriateness X of the map information estimated in step S203 of FIG. 2 is a binary value and it is estimated that there is no moving body, X=1 is set as the environmental information. When it is estimated that there is the moving body, X=0 is set as the environmental information. Accordingly, a case in which the appropriateness X is 1 indicates that appropriate map information is generated.

In the above description, whether there is the information regarding the moving body in the map information generated in step S201 of FIG. 2 and whether there is the moving body in the imaged data of the sensor 101 in FIG. 1 are estimated by the pattern matching in which the SSD. However, any method may be used as long as the similarity can be calculated. Instead of the SSD, a sum of absolute difference (SAD) may be used. An image recognition scheme in which a learned model such as a convolution neural network (CNN) is used may be used as long as the scheme is a method capable of determining whether there is a moving body.

The appropriateness X of the map information is estimated with a binary value based on whether there is a moving body. However, it may be indicated that the appropriate map information is generated when the appropriateness X is a large value. Therefore, the appropriateness X of the map information may be displayed with a multi-value. That is, for example, based on the number of detected moving bodies N, a reciprocal (1/N) of the number of detected moving bodies or a negative value (−N) of the number of detected moving bodies may be displayed as the appropriateness X.

The imaged data used for the pattern matching may be obtained by a sensor capable of collecting a surrounding environment of the sensor 101 in FIG. 1. Therefore, a sensor with an overhead view different from that of the sensor 101 mounted on the mobile object 100 may be provided and used.

The appropriateness X of the map information may be estimated based on whether there is a repetition pattern (shape) as the environmental information of the surrounding environment of the sensor 101 in FIG. 1. That is, when the appropriateness X of the map information is estimated in step S203 of FIG. 2, it may be determined whether there is a repetition shape in the imaged data by integrating a result of frequency analysis of each piece of imaged data.

Specifically, an amplitude spectrum is calculated by performing discrete Fourier transform on each piece of imaged data and it is determined whether there is a frequency component with an amplitude equal to or greater than a predetermined threshold at a frequency of a predetermined range excluding a direct-current component (0 Hz). When there is the frequency component with the amplitude equal to or greater than the predetermined threshold, it is determined that there is the repetition shape. When there is no frequency component with the amplitude equal to or greater than the predetermined threshold, it is determined that there is no repetition shape.

When the result of the frequency analysis of each piece of imaged data is integrated and the appropriateness X of the map information is estimated, the appropriateness X may be a reciprocal of the number of pieces of imaged data in which there is the repetition shape. Thus, it can be indicated that as the number of pieces of imaged data in which there is the repetition shape is larger, the appropriateness X is increased and the appropriate map information is generated. In this way, the environmental information may include any one of the illumination change, whether there is a moving body, and whether there is a repetition pattern.

### Fourth Embodiment

In the first to third embodiments, the method of notifying of the appropriateness of the map information which is being generated by estimating feature points of the object and the environmental information from the sensor information or the map information which is being generated has been described.

In the fourth embodiment, the appropriateness is estimated based on sensor information or whether a closed route is formed in a movement path of a mobile object or a sensor mounted on a mobile object. A block diagram and a processing flow in which the appropriateness of the map information is estimated in the fourth embodiment may be the same as FIGS. 1 and 2 described in the first to third embodiments. Hereinafter, a detailed process of step S203 which is a difference from the first to third embodiments will be described.

In the fourth embodiment, the appropriateness X of the map information estimated in step S203 of FIG. 2 is determined based on whether a path of the mobile object 100 is a closed route based on position and posture information of the sensor 101 acquired by the sensor information acquisition unit 103 in FIG. 1. Whether the path is the closed route is determined based on whether a difference amount in the position and posture information between movement start and end times is less than a predetermined threshold. When the difference amount is less than the predetermined threshold, it is determined that the path is the closed route. When the difference amount is equal to or greater than the predetermined threshold, it is determined that the path is not the closed route.

A case in which the appropriateness X of the map information estimated in step S203 of FIG. 2 is a binary value and it is determined in step S203 that the path is the closed route indicates that the appropriate map information is generated. A section of the above-described closed route is a section at the start and end times and a state of the closed state may be able to be estimated throughout the entire section. Accordingly, the section may be divided to perform the determination in an integrated manner. Specifically, a difference in the position and posture information of the sensor between two time points is used.

When position and posture information of the sensor at each time point is Pi and position and posture information of the sensor at a present time is Ps, position and posture information Pt of the sensor which is at a position closest to Ps is searched for between Ps and Pi at a previous time point before a time or more of a predetermined threshold. Then, a difference distance D (D=ABS (Pt−Ps)) of the position and posture information of the sensor is calculated. In the searching of the position and posture information Pt of the sensor, a difference value between Ps and each Pi is calculated and Pi located at a position at which an absolute value of the difference value is the minimum is set. The predetermined threshold is a value designated by the user or set in advance by the system. Further, a time used as the threshold value for selecting Pi serves as a reference, but an operation amount may serve as a reference from a relation with a movement speed of the mobile object.

When the section is divided, the appropriateness X of the map information estimated in step S203 of FIG. 2 is a multi-value and X=D is set. In this case, it is indicated that the more appropriate map information is generated as the appropriateness X is closer to 0.0.

As described above, by determining whether a closed roue is formed using the similarity calculated based on the position and posture information of the sensor at two time points and estimating appropriateness of the map information in accordance with the determination, it is possible to notify of the appropriateness of the map information which is being generated.

In the fourth embodiment, when the map information of step S201 of FIG. 2 is generated, a closed route may be detected. Further, the map information at that time may be formed with high accuracy (see M. A Raul, J. M. M. Montiel and J. D. Tardos, “ORB-SLAM: A Versatile and Accurate Monocular SLAM System” Trans. Robotics vol. 31, 2015) and the appropriateness X of the map information may be estimated based on the correction amount of each piece of position and posture information in the forming of the map information with high accuracy.

In this case, the appropriateness X of the map information estimated in step S203 of FIG. 2 is calculated based on the correction amount at each time point in the forming of the map information with high accuracy. Specifically, a method disclosed in M. A Raul, J. M. M. Montiel and J. D. Tardos, “ORB-SLAM: A Versatile and Accurate Monocular SLAM System” Trans. Robotics vol. 31, 2015 is used as a correction method for the forming of the map information with high accuracy at each time point. A correction amount Ci at each time point is set as a difference amount before and after correction and a correction average value Cm is an average value of Ci.

The appropriateness X of the map information estimated in step S203 of FIG. 2 is a multi-value and X=Cm is set. Accordingly, in this case, it is indicated that the more appropriate map information is generated as the appropriateness X is closer to 0.0. At this time, for example, the appropriateness X=a total sum (X=SUM(Ci)) of correction amounts may be set. Further, the appropriateness X may be calculated based on not the correction amount at each time point but a total distance of a route which is a correction target.

In the fourth embodiment, the section of the closed route may be determined based on similarity of luminance between pieces of imaged data and the appropriateness of the map information may be determined based on the degree (ratio) of the section of the closed route to the entire route. In this case, the appropriateness X of the map information estimated in step S203 of FIG. 2 is determined based on whether a path of the mobile object 100 in FIG. 1 is a closed route.

In the determination of whether the path is the closed route, the estimation is performed based on whether there is a significant difference between imaged data at a present time point and imaged data at a previous time point. Here, at a threshold or more designated by the user or set in advance by the system, the imaged data at the previous time point is used. The significant difference is calculated from T tests of two samples for luminance of the imaged data.

Specifically, in the case of the T tests of two samples in which there is correspondence of a significance level of 1%, a reference value P=2.576 is set. When an absolute value of a calculated T value is less than the reference value P, it is estimated that there is no significant difference between the imaged data at the two time points. Accordingly, when the path of the mobile object 100 is a closed route and the absolute value is equal to or greater than the reference value P, there is a significant difference between imaged data at two time points, and therefore the path of the mobile object 100 is not the closed path. The reference value P is designated from the significance level in accordance with a value set by the user or a normal distribution.

When the appropriateness X of the map information estimated in step S203 of FIG. 2 is a binary and a path of the mobile object 100 in FIG. 1 is estimated to be a closed route, X=1 is set. When the path is estimated not to be the closed route, X=0 is set. Accordingly, the case in which the appropriateness X is 1 indicates that the appropriate map information is generated.

In the calculation of the above-described significant difference, the present embodiment also includes a configuration in which a method such as SSD or SAD in which similarity between the imaged data is calculated is used in the third embodiment. In this case, when the similarity is less than a predetermined threshold, it is assumed that there is no significant difference between imaged data at two time points. When the similarity is equal to or greater than the predetermined threshold, it is assumed that there is a significant difference between imaged data at two time points.

The present embodiment also includes a configuration in which affine transformation is used based on an angle of field of each piece of imaged data or a difference in a direction of the mobile object 100 in FIG. 1 before it is determined whether there is a significant difference between two pieces of imaged data. A method other than affine transformation may be used as long as a geometric difference between two pieces of imaged data is corrected. Further, not only 2-dimensional transformation but also 3-dimensional transformation may be used.

### Fifth Embodiment

In the first to fourth embodiments, as described above, the appropriateness of the map information which is being generated can be notified of based on the sensor information, the surrounding environment of the map information which is being generated, and whether the closed route is formed.

In the fifth embodiment, a dual-system sensors of a camera sensor generating map information and a movement amount sensor measuring a movement amount of a mobile object is included. Appropriateness of map information is estimated based on a difference between a movement amount (a first movement amount) of the camera sensor estimated based on the map information which is being generated and a movement amount (a second movement amount) of a mobile object in a real space estimated from sensor information acquired by the movement amount sensor.

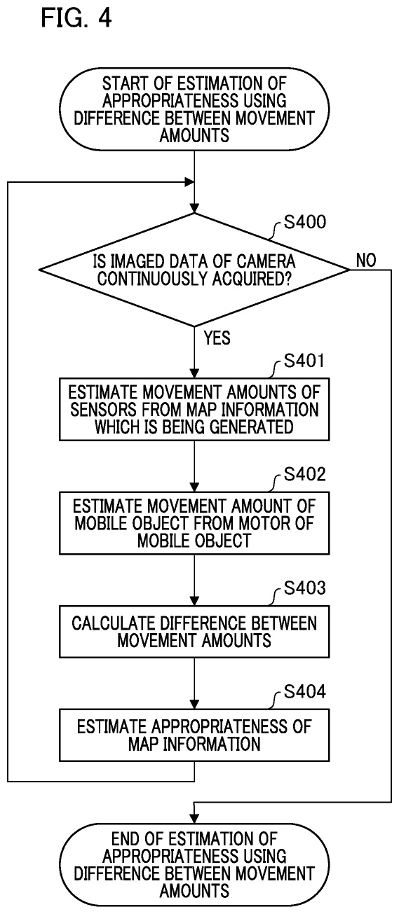

FIG. 4 is a flowchart illustrating a processing flow in which appropriateness of map information according to the fifth embodiment is estimated. An operation of each step of FIG. 4 is performed by causing a computer in the information processing device 102 to execute a computer program stored in a memory.

A mobile object on which a camera is mounted as a sensor collects map information, generates a 3-dimensional map, and estimates appropriateness of the 3-dimensional map information. Here, the map information is 3-dimensionally arrayed feature points detected from an image sensor.

As the sensor, in addition to the above-described camera sensor generating the map information, a movement amount sensor that measures a movement amount of the mobile object by measuring a rotation amount of a movement motor moving the mobile object is included. Then, the appropriateness of the map information which is being generated is estimated based on a difference between a movement amount of the camera sensor estimated from the map information and a movement amount of a mobile object calculated from a rotation amount of the movement motor included in the mobile object.

A detailed processing flow of step S203 of FIG. 2 in the fifth embodiment will be described with reference to the flowchart of FIG. 4.

In step S400, it is determined whether imaged data of the cameras are continuously acquired. In the case of Yes in step S400, the process proceeds to step S401. In the case of No, the estimation of the appropriateness performed using the difference between the movement amounts ends.

In step S401, a movement amount of the camera sensor is estimated from the map information which is being generated. That is, a movement amount MV of the sensor 101 in a virtual space is estimated using geometric transformation based on the map information generated by the map generation unit 104.

The movement amounts of the mobile object 100 and the sensor 101 in FIG. 1 are estimated while the sensor information acquisition unit 103 acquires the sensor information.

In step S402, the movement amount MR of the mobile object 100 in the real space is estimated based on the rotation amount of the movement motor included in the mobile object 100.

The movement amount MR of the mobile object 100 in the real space may be estimated by a method in which a movement distance of the mobile object 100 between predetermined time points can be calculated. For example, a method of calculating the movement distance using Global Positioning System (GPS) may be used. Further, a method of calculating the movement amount from a motion of the mobile object may be used.

For example, a fixed camera with an overhead view that includes a rotational mechanism may be provided. The movement amount MR may be calculated based on a rotation amount of a motor that rotates when the fixed camera tracks the mobile object. Alternatively, for example, a six-axis acceleration sensor or the like may be provided in the mobile object and the movement amount MR may be calculated based on an output of the six-axis acceleration sensor.

Subsequently, in step S403, a difference between the movement amounts MV and MR is calculated based on the movement amount MV of the sensor estimated in step S401 and the movement amount MR of the mobile object estimated in step S402.

Specifically, a difference D between the movement amounts MV and MR is calculated by subtraction of the movement amounts MV and MR after conversion into a millimeter unit system in the real space. The subtraction may be performed after conversion into a common unit system in a common space even when a subtraction method performed after conversion into the millimeter unit system in the real space is not used. As the common space, for example, a route in a 2-dimensional plane or a 3-dimensional space is used. Further, a space or a unit system individually defined in the system may be used.

Subsequently, in step S404, the map appropriateness estimation unit 105 in FIG. 1 estimates the appropriateness of the map information based on the difference D between the movement amounts calculated in step S403, and the process returns to step S400. The appropriateness X of the map information estimated in step S404 of FIG. 4 is a multi-value and X=ABS (the difference D between the movement amounts) is set. Accordingly, it is indicated that the reliability is higher and the more appropriate map information is generated as the appropriateness X is closer to 0.0. Alternatively, when the difference D between the movement amounts is equal to or less than a predetermined value, the map information may be determined to be appropriate. When the difference D is greater than the predetermined value, the map information may be determined to be inappropriate. Then, the determination may be notified of

As described above, in the fifth embodiment, the appropriateness of the map information is estimated based on the difference between the movement amount of the mobile object estimated from the map information generated based on the output of the camera sensor and the movement amount of the mobile object estimated from the output of the movement amount sensor. Accordingly, the appropriateness of the map information which is being generated can be notified of.

As described above, in the fifth embodiment, the appropriateness of the map information estimated in step S203 of FIG. 2 is calculated based on a difference between the movement amounts of the sensor information acquired from two types of sensors at the same time.

However, the appropriateness X of the map information may be estimated based on a difference between a movement amount of the sensor estimated from the map information which is being generated and a movement amount of the mobile object calculated from imaged data acquired from the camera sensor.

That is, the movement amount MR of the mobile object calculated in step S402 of FIG. 4 may be calculated from an optical flow in which, for example, a LUCASKANADE method for imaged data is used. In this method, since a motion vector of each pixel is calculated, an average vector of all the motion vectors is set as the movement amount MR. That is, the second movement amount is estimated from the motion vectors obtained from the sensor information.

The difference D between the movement amounts calculated in step S403 of FIG. 4 is set to a difference (D=MV−MR) between two types of movement amounts as in the present embodiment, the appropriateness X of the map information estimated in step S404 is a multi-value, and X=ABS (the difference D between the movement amounts) is set. Accordingly, it is suggested that the more appropriate map information is generated as the appropriateness X is closer to 0.0. As described above, when the difference D between the movement amounts is equal to or less than the predetermined value, the map information may be determined to be appropriate. When the difference D is greater than the predetermined value, the map information may be determined to be inappropriate. Then, the determination may be notified of.

As described above, the movement amount of the mobile object is calculated from the optical flow in which a LUCASKANADE method is used, but any scheme may be used as long as a movement amount of each pixel can be calculated from the imaged data

In the foregoing first to fifth embodiments, the sensor 101 in FIG. 1 is mounted on the mobile object 100. However, the sensor 101 may be disposed in a device different from the mobile object 100 may be disposed and communicate with the information processing device 102.

Further, the sensor 101 may be, for example, a sensor such as LIDAR or may be a sensor in which the map generation unit 104 can generate the map information. The appropriateness estimated by the map appropriateness estimation unit 105 in FIG. 1 may be calculated by distinguishing appropriateness of an entire region of the map information generated by the map generation unit 104 from appropriateness of each local region.

As described above, in the first embodiment, by estimating the appropriateness of the map information using the detection reliability of the feature points of the object, it is possible to notify of the appropriateness of the map information which is being generated. In the second embodiment, by estimating the appropriateness of the map information using the distribution of the feature points of the object, it is possible to notify of the appropriateness of the map information which is being generated. In the third embodiment, by estimating the appropriateness of the map information using the surrounding environment, it is possible to notify of the appropriateness of the map information which is being generated.

In the fourth embodiment, by estimating the appropriateness of the map information using the similarity calculated based on the position and posture information of the sensor at two time points, it is possible to notify of the appropriateness of the map information which is being generated. In the fifth embodiment, by estimating the appropriateness of the map information using the difference between the movement amount of the sensor mobile object estimated from the map information and the movement amount of the mobile object estimated form the position and posture information of the sensor, it is possible to notify of the appropriateness of the map information which is being generated.

Further, the estimation methods according to the foregoing first to fifth embodiments may be combined appropriately to estimate the appropriateness of the map information. Accordingly, it is possible to estimate the appropriateness more smoothly with high accuracy.

In the first to fifth embodiments, the mobile object 100 which is a movement device in FIG. 1 has a configuration of an AMR (autonomous traveling robot device) and includes a driving device such as a movement motor or an engine moving (running) the ARM or a movement direction control device that changes a movement direction of the AMR. A movement control unit that controls a driving amount of the driving device or a movement direction of the movement direction control device is included.

The movement control unit includes a CPU serving as a computer and a memory storing a computer program, and communicates with other devices. Accordingly, for example, the information processing device 102 is controlled and map information, position and posture information, traveling route information, or the like is acquired from the information processing device 102.

The AMR which is the mobile object 100 is configured such that a movement control unit controls a movement direction, a movement amount, or a movement route of the AMR based on the map information generated by the information processing device 102 or the searched traveling route.

While the present invention has been described with reference to exemplary embodiments, it is to be understood that the invention is not limited to the disclosed exemplary embodiments. The scope of the following claims is to be accorded the broadest interpretation to encompass all such modifications and equivalent structures and functions. In addition, as a part or the whole of the control according to the embodiments, a computer program realizing the function of the embodiments described above may be supplied to the information processing device through a network or various storage media. Then, a computer (or a CPU, an MPU, or the like) of the information processing device may be configured to read and execute the program. In such a case, the program and the storage medium storing the program configure the present invention.

This application claims the benefit of Japanese Patent Application No. 2021-139224 filed on Aug. 27, 2021, which is hereby incorporated by reference herein in its entirety.

What is claimed is:

1. An information processing device comprising at least one processor or circuit configured to function as:
a sensor information acquisition unit configured to acquire sensor information from one or more sensors;
a map information generation unit configured to generate map information around the sensor based on the sensor information;
a map appropriateness estimation unit configured to estimate appropriateness of the map information based on at least one piece of information between the sensor information and the map information generated by the map information generation unit; and
a notification unit configured to notify of the appropriateness.

2. The information processing device according to claim 1, wherein the map appropriateness estimation unit calculates detection reliability of feature points of an object included in the map information and estimates the appropriateness based on the detection reliability.

3. The information processing device according to claim 2, wherein the detection reliability of the feature points is calculated based on a difference between luminance of positions of the feature points and surrounding luminance of the feature points.

4. The information processing device according to claim 2, wherein the notification unit notifies of the detection reliability with a numerical value or one of a size, a shape, and a color of the feature point.

5. The information processing device according to claim 1, wherein the map appropriateness estimation unit estimates the appropriateness based on a distribution of the feature points of the object calculated from the sensor information.

6. The information processing device according to claim 1, wherein the map appropriateness estimation unit estimates environmental information based on the map information and estimates the appropriateness based on the environmental information.

7. The information processing device according to claim 6, wherein the environmental information includes one of an illumination change, whether there is a moving body, and whether there is a repetition pattern.

8. The information processing device according to claim 1, wherein the map appropriateness estimation unit estimates the appropriateness based on whether a closed route is formed in a movement path of the sensor based on the sensor information.

9. The information processing device according to claim 1,
wherein the sensor information acquisition unit acquires position and posture information of the sensor, and
wherein the map appropriateness estimation unit calculates similarity between the pieces of position and posture information of two time points acquired by the sensor information acquisition unit and estimates the appropriateness based on the similarity.

10. The information processing device according to claim 1, wherein the map appropriateness estimation unit estimates the appropriateness based on a difference between a first movement amount of the sensor estimated from the map information and a second movement amount of the sensor estimated from the sensor information.

11. The information processing device according to claim 10, wherein the second movement amount is estimated from a motion vector obtained from the sensor information.

12. A mobile device comprising at least one processor or circuit configured to function as:
a sensor information acquisition unit configured to acquire sensor information from one or more sensors;
a map information generation unit configured to generate map information around the sensor based on the sensor information;
a map appropriateness estimation unit configured to estimate appropriateness of the map information based on at least one piece of information between the sensor information and the map information generated by the map information generation unit;
a notification unit configured to notify of the appropriateness; and
a movement control unit configured to control movement based on the map information.

13. An information processing method comprising:
acquiring sensor information from one or more sensors;
generating map information around the sensor based on the sensor information;
estimating appropriateness of the map information based on at least one piece of information between the sensor information and the map information; and
notifying of the appropriateness.

14. A non-transitory computer-readable storage medium configured to store a computer program comprising instructions for executing following processes:
acquiring sensor information from one or more sensors;
generating map information around the sensor based on the sensor information;
estimating appropriateness of the map information based on at least one piece of information between the sensor information and the map information; and
notifying of the appropriateness.
